(19) United States
(12) Patent Application Publication
(10) Pub. No.: US 2025/0094771 A1
(43) Pub. Date: Mar. 20, 2025

(54) CO-OPERATIVE AND CO-ORDINATED APPROACH TO SOLVE PROBLEMS REQUIRING ARTIFICIAL INTELLIGENCE/MACHINE LEARNING

(71) Applicant: AT&T Intellectual Property I, L.P., Atlanta, GA (US)

(72) Inventors: Deven Panchal, Middletown, NJ (US); Dan Musgrove, Jackson, NJ (US); David H. Lu, Irving, TX (US); Isilay Baran, Morganville, NJ (US)

(73) Assignee: AT&T Intellectual Property I, L.P., Atlanta, GA (US)

(21) Appl. No.: 18/471,048

(22) Filed: Sep. 20, 2023

(51) Int. Cl. G06N 3/045; G06N 3/08

(52) U.S. Cl. CPC G06N 3/045; G06N 3/08

(57) ABSTRACT

Aspects of the subject disclosure may include, for example, combining a plurality of machine learning (ML) models to form a composite model, the plurality of ML models including a first ML model trained on first local data received at a first network location and added models including a second ML model through an nth ML model, respective added models of the added models each being respectively trained on respective training data at a respective network location remote from the first network location; receiving input data at the first network location; providing the input data to the composite model; receiving, from the composite model, a conclusion about a status of the input data; receiving an indication to update one or more models of the plurality of ML models; and updating the one or more models according to the indication. Other embodiments are disclosed.

### FIELD OF THE DISCLOSURE

The subject disclosure relates to method and apparatus for solving problems (across industries) requiring Artificial Intelligence and Machine Learning. The method uses a co-operative and co-ordinated approach by sharing machine learning models among multiple entities and combining them for use at a single location.

### BACKGROUND

Many practical machine learning (ML) models and other artificial intelligence (AI) tools require large and diverse training datasets to be able to generalize well so they can perform well on new unseen data. However, training such a model can be a time intensive and compute intensive process for single data processing platform to accomplish.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B is a block diagram illustrating an example, non-limiting embodiment of a system functioning within the communication network of FIG. 1 in accordance with various aspects described herein.

FIG. 2C is a block diagram illustrating an example, non-limiting embodiment of a system functioning within the communication network of FIG. 1 in accordance with various aspects described herein.

FIG. 2D depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for combining multiple machine learning models in a cooperative model. A system and method receive local data and events at a network location and train a local model. Further, the system and method receive or onboard additional trained artificial intelligence or machine learning models from other network locations. The models are continuously updated with freshly trained models. The cooperative model is a combination of the local and received models. Other embodiments are described in the subject disclosure.

Many practical ML models require large and diverse training datasets to be able to generalize well so they can perform well on new unseen data. For example, problems in remote sensing, cybersecurity, network analytics, image classification, etc. typically require a lot of diverse data so that they may be solved using an ML based approach. Embodiments in accordance with the solution discussed herein address this problem of how the ML models trying to solve problems like these can be trained on large and diverse datasets to make them more accurate.

Since these complex models train on large amounts of data and can consist of billions of parameters in the case of complex deep learning models, such model training is a time intensive and compute intensive process and cannot often be practically achieved on a single machine. Hence it is beneficial to parallelize the training process using data parallelism or model parallelism or using purpose-built hardware. Embodiments in accordance with the disclosure herein solve this problem using a novel model sharing and combining approach.

Many of these problem domains discussed earlier often lend themselves very well to the concept of training the model on some data at a location and reusing the model at a different location on new data. As an example, it may be that the tasks that these models are built to perform are required to be done at most companies or other entities. So, these models can be reused on new data with or without extra training or retraining at a completely new site. Embodiments in accordance with the solution herein exploit this fact.

Currently, there are data sovereignty, data location, and data transfer regulations like GDPR, CCPA being instituted in many countries and jurisdictions. Such regulations make it difficult or impossible to transfer data to a geographically distant site to train a model. So, model sharing becomes important. Embodiments in accordance with the approach herein show how we can train the model locally on local data and then share the model with a new remote site to create an AI pipeline to augment the capabilities of a similar model at that new site or do something better with the model. In a way, this training of models on local data, and sharing them to create a solution at a remote site, for that remote site, harnesses the power of crowdsourcing of data and compute resources from other sites. This co-operative and coordinated approach to solving problems can help solve them much more efficiently too.

In use cases described herein, it is demonstrated how to set up a co-operative and coordinated defense that identifies and classifies attack types against a problem like the Distributed Denial of Service (DDOS) attack, that itself is carried out in a co-operative fashion by bad actors. So, this co-operative and coordinated paradigm is powerful to solve problems that are inherently distributed and cooperative in their cause or origin.

This kind of sharing of ML models could in fact be envisioned to be happening also between a vendor who created the ML model and a client who wants to consume the ML model. Right now, there is no framework for sharing, monetizing, licensing, and deploying AI/ML models across entities and geographical sites. The Acumos platform may be used in some examples to solve this problem by providing a framework to do all the above.

One or more aspects of the subject disclosure include training a first machine learning (ML) model on first local data received at a first site, and combining the first ML model with a plurality of other ML models to form a composite model, each respective ML model of the plurality of ML models trained by a respective site of a plurality of sites using respective local data at the respective site. Further aspects of the subject disclosure include receiving input data at the first site, providing the input data to the composite model, determining, responsive to the composite model, a status of the input data, wherein the status comprises one of malicious data and benign data, and isolating the input data responsive to a determination of a status of malicious data.

One or more aspects of the subject disclosure include combining a plurality of machine learning (ML) models to form a composite model, the plurality of ML models including a first ML model trained on first local data received at a first network location and added models including a second ML model through an nth ML model, respective added models of the added models each being respectively trained on respective training data at a respective network location remote from the first network location, receiving input data at the first network location; providing the input data to the composite mode, and receiving, from the composite model, a conclusion about a status of the input data. Aspects of the subject disclosure further include receiving an indication to update one or more models of the plurality of ML models and updating the one or more models according to the indication.

One or more aspects of the subject disclosure include training a local machine learning (ML) model on first local data received at a first network location, creating, by the processing system, a local containerized microservice based on the local ML model, and receiving, from a plurality of remote network locations, additional containerized microservices, each respective additional containerized microservice of the additional containerized microservices being created at a respective remote network location from a respective ML model, each respective ML model being trained at the respective remote network location on respective training data. Aspects of the subject disclosure further include combining the local containerized microservice and the additional containerized microservices to form a composite model, receiving input data at the first network location, providing the input data to the composite model, and receiving from the composite model, a conclusion about a status of the input data.

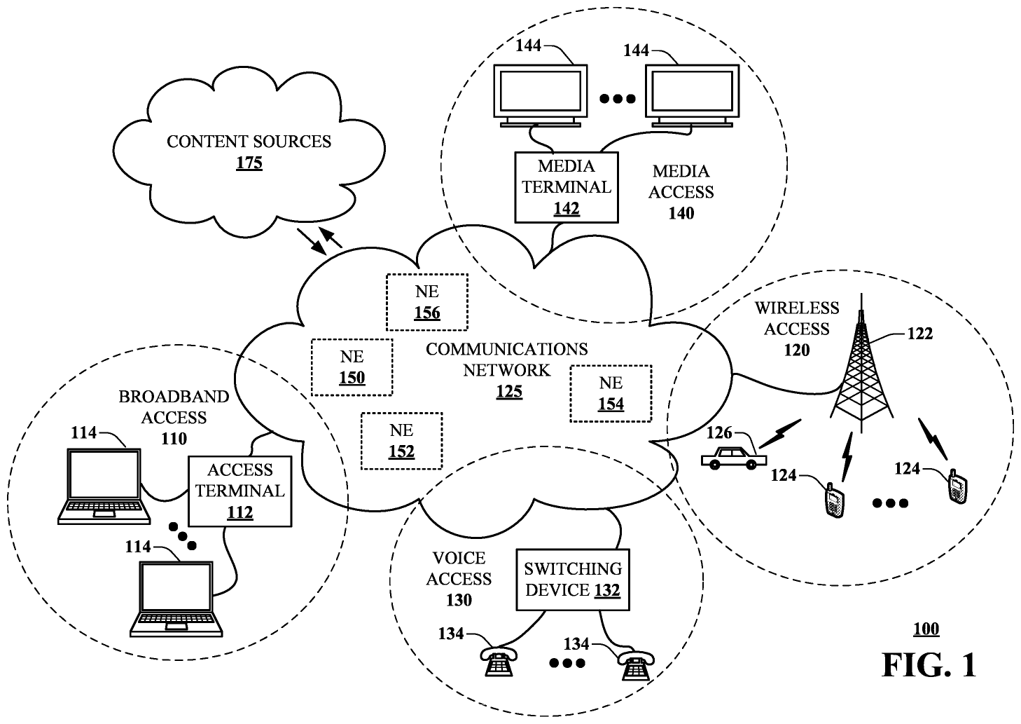

Referring now to FIG. 1, a block diagram is shown illustrating an example, non-limiting embodiment of a system 100 in accordance with various aspects described herein. For example, system 100 can facilitate in whole or in part detecting malicious received data at a web site or network location using a composite AI pipeline formed from multiple ML models. The ML models include models trained locally and models trained at remote network sites. The operation of the ML models is coordinated and continuous, and the models are continuously updated to provide the best performance for identifying malicious traffic. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VOIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VOIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

Various embodiments of the communications network 125 can be used to cooperatively implement machine learning models and artificial intelligence tools. Many machine learning and deep learning problems may be solved in a co-operative or a coordinated fashion by multiple worker nodes acting in concert. There are many reasons for this. For example, some models train on a large amount of data, so training can be a very compute intensive and time intensive process. For example, in the case of complex deep neural networks, training data may consist of billions of parameters or more. Further, the parameters must be tuned during a training phase and subsequently.

To manage such a large training requirement, the training paradigm may be thought of in terms of data parallelism or model parallelism. In a data parallelism training phase, each worker node trains a copy of the model on a different batch of data and then communicates or shares results to synchronize the model parameters and gradients across all worker nodes. In the model parallelism training phase, the model is divided into parts that are trained in parallel on different worker nodes on the same dataset. The worker nodes then communicate the global model parameters with other worker nodes.

Subsequently, two or more worker nodes may cooperate to solve substantial ML or AI problems. There are many examples of problems that may benefit from combined data processing abilities of multiple worker nodes operating in cooperation. Examples include problems in remote sensing such as land cover mapping and change detection for disaster monitoring and land use etc. Such remote sensing problems rely heavily on various types of input data that need to be analyzed together. In another example, problems in computer security that deal with botnet attacks, distributed denial of service, digital forensics and fraud, may require cooperative and coordinated efforts. Such efforts may use various data inputs, various compute infrastructure and various intelligence. By definition, the very behavior of these attacks is coordinated. There are many other problems that lend themselves to the co-operative and coordinated ML-based solution paradigms.

In another example, there exist current or future limitations on sharing or communication of data such as training data. Aspects of data sovereignty, data location, data transfer may be subject to limiting regulations such as the General Data Protection Regulation (GDPR) of the European Union or the California Consumer Privacy Act (CCPA). Such provisions may limit an entity's ability to transfer data to a geographically distant site to train a model, for example. In such cases, model sharing becomes important. Such legal requirements may limit the ability of entities to handle data. The entities need to comply with the laws and other governance structures in place. Further, there are very strict legally binding obligations on the transfer of data outside where it was collected, as well as where and to whom data will be transferred. All such requirements further reinforce the concept and need of being able to share trained models rather than sharing data.

In some embodiments, a ML model supplier or vendor could be a person or an entity, such as a group in an organization or a company, that may want to share an ML model with another person, organization or company. The receiver of the ML model may be referred to as the ML model consumer or the client. Such arrangements are common when a client needs ML intelligence and models to accomplish a certain task or integrate with its existing business applications and a vendor who has the expertise in building ML and Deep Learning models steps in to help build those models for the client.

Platforms have been developed to assist in sharing ML models. An example is the Acumos AI platform which enables training, integration and deployment of different models. Other examples are available or may be readily developed as well.

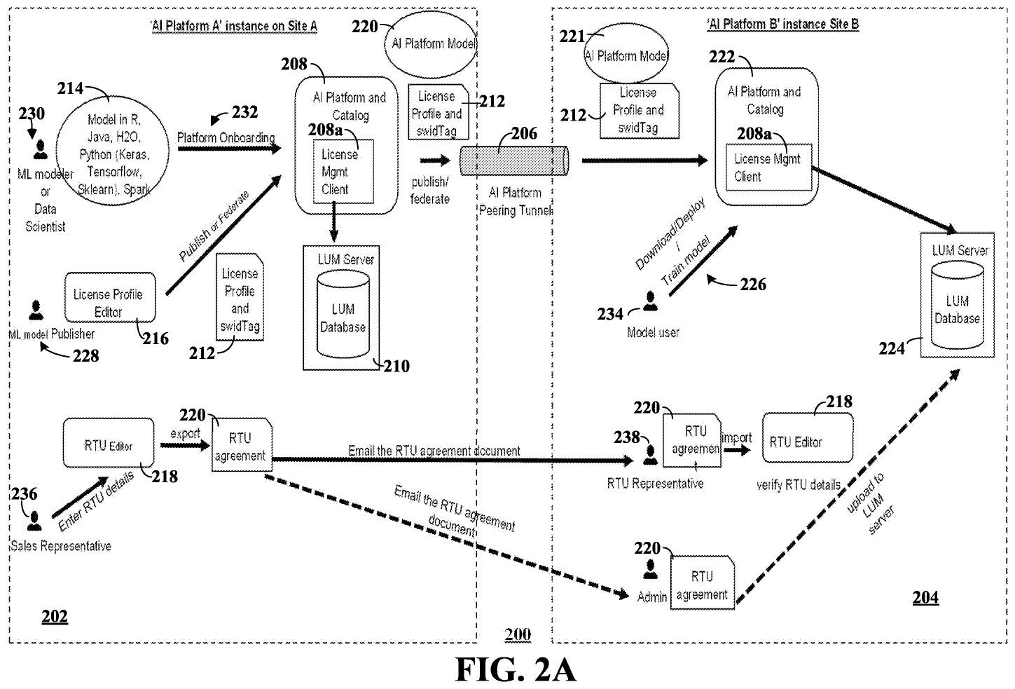

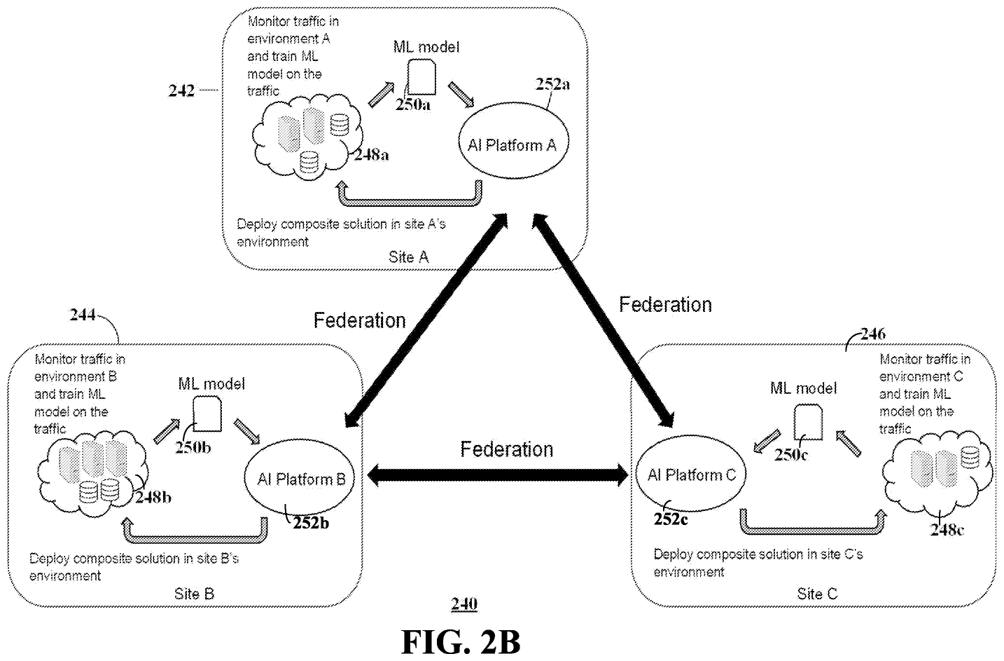

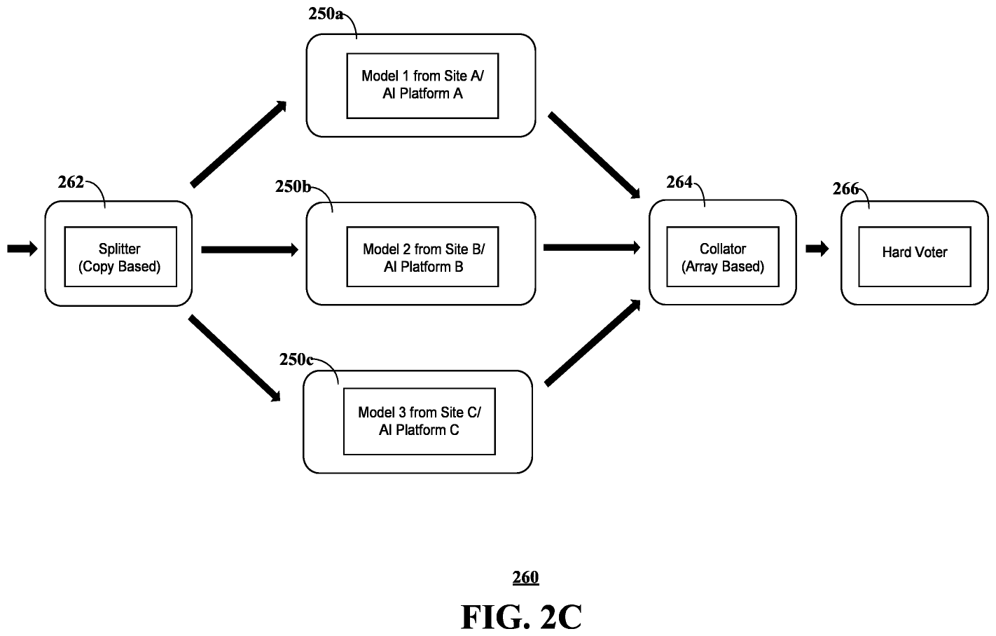

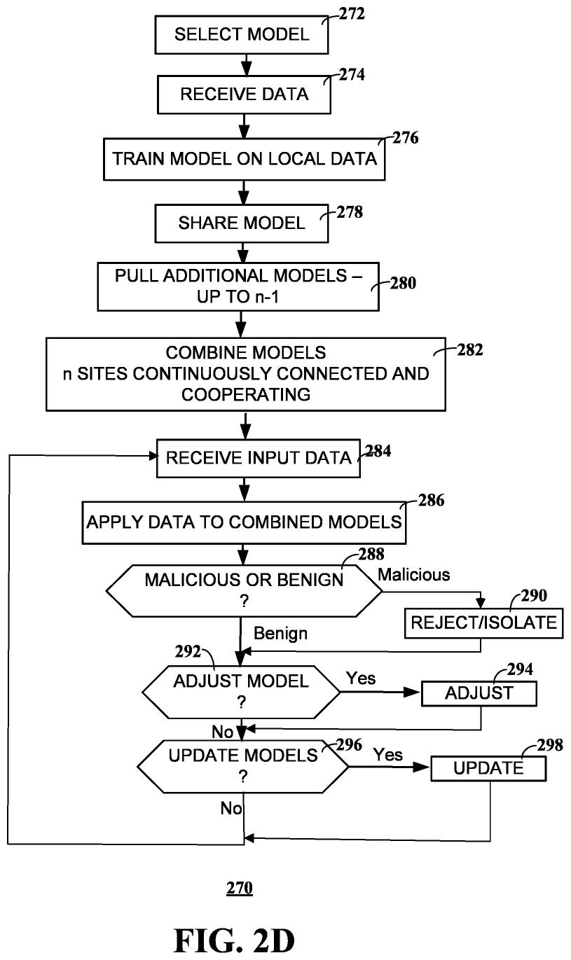

FIG. 2A is a block diagram illustrating an example, non-limiting embodiment of a system 200 functioning within the communication network of FIG. 1 in accordance with various aspects described herein. The system 200 permits a vendor at a vendor site 202 to share with a client at a client site 204 one or more ML models, AI tools or other functional components. In examples, the vendor site 202 and the client site may be implemented as one or more network locations accessible over a network such as the public internet. Other embodiments may be envisioned.

In exemplary embodiments, the system 200 may be implemented in accordance with the Acumos AI Project (“Acumos”) of the Linux Foundation. Acumos is an open-source project that in one aspect forms an AI, machine learning marketplace. Users can create machine learning models outside Acumos then bring them into Acumos, wrap then in a common application programming interface (API) and create containerized microservices. Acumos generally includes a federated platform for managing artificial intelligence (AI) and machine learning (ML) applications and sharing AI models. Acumos enables building, sharing and deploying AI applications such as from the vendor site 202 to the client site 204. Acumos also has a design studio so the user can chain and create AI pipelines with existing models that are compatible with each other. The resulting models, as well as those AI pipelines can be deployed to various cloud environments. Further, Acumos offers a systematic framework and tooling for sharing, and licensing (referred to as federation licensing) of rights of usage of machine learning models. Other embodiments include similar but different structure providing similar functionality to Acumos.

In the example, the system 200 implements an AI platform which allows peering of local or remote instances of the AI platform. Further, the AI platform allows sharing licensing of ML models and other features. In the example embodiment, the system 200 includes the vendor site 202, designated in the figure as AI Platform A Instance on Site A, and the client site 204, designated in the figure as AI Platform B Instance Site B. The vendor site 202 and the client site 204 communicate data and other information through an AI platform peering tunnel 206.

The vendor site 202 in the embodiment of FIG. 2A includes an AI platform and catalog 208, a license usage manager (LUM) server 210, a license profile 212, a model editor 214 and a license profile editor 216 and a right-to-use editor 218, and an AI platform model. Similarly, the client site includes an AI platform and catalog 222, a LUM server 224, the license profile 212, and an RTU editor 218. The embodiment of FIG. 2A is exemplary only. Other embodiments may include additional or alternative elements and functions.

In operation, when a user at the client site 204 wishes to federate with another AI platform instance such as the vendor site 202, the client site 204 first establishes connectivity with the vendor site 202. Any suitable peering negotiation may occur, either automatically or manually. In an example, the client site 204 and the vendor site 202 exchange secure socket layer (SSL) certificates. Next, one or both of the sites can add the other site as a federation peer. Access to a catalog of ML models and other tools and information is then provided to the client site 204.

Upon completion of the federation process, the user at the client site 204 is able to view information about catalogs such as the AI platform and catalog 208 of the vendor site 202. The catalogs contain, for example, ML models, solutions, artifacts and documentation. The user can further retrieve and deploy 226 the models and solutions as well as associated metadata and artifacts to the AI platform and catalog of the client site 204. In embodiments, the models and solutions can be deployed as microservices to various target infrastructures, such as Amazon Web Services (AWS), Microsoft Azure, Kubernetes, and others.

The AI platform further includes a licensing component including the LUM server 210 and an LUM database of the vendor site 202 and the similar LUM server 224 and LUM database of the client site 204. A ML model publisher 228 can edit a license profile in license profile editor 216 of the vendor site 202.

In operation, to set licensing of ML models at the vendor site 202, a model creator 230 creates the model on any suitable framework or in any suitable language. Example frameworks include H2o, sklearn, keras, Tensorflor and ONNX. Example languages include Python, Java and R. The model may then be onboarded 232 to the AI platform at the vendor site 202. The model creator 230 can add descriptions, additional metadata and other information to the AI platform model 221 and may share the AI platform model 221. In embodiments, the AI platform includes a design studio for a user such as the model creator 230 to create composite solutions using the AI platform model 221 and other models. The AI platform model 221 or a composite model may be identified such as by a swidTag of the license profile 212. A swidTag or software identification tag provides a way to track software installed on managed devices. Optionally in some embodiments, the model creator 230 can provide a model profile for the model.

Separately, a ML model publisher 228 uses the license profile editor 216 to create the license profile. The ML model publisher 228 may further specify a requirement to obtain rights to use (RTU) the model. The license profile 212 is a json file that contains information such as a license key, a license name, a copyright year, a copyright owner, a copyright suffix, a contact name, a contact uniform resource locator (URL), or a place to purchase the model, a contact email address, and whether or not right to use is required. The license profile 212 can be added by the model creator when onboarding the model to the AI platform and catalog 208 or the license profile 212 can be added later such as by editing the “License Profile” section for the model which uses the license profile editor 216.

The ML model publisher 228 then uploads the license profile 212 to the AI platform and catalog 222. The ML model publisher 228 may initiate a publish action or a federate action for the model. This action registers the mode in the LUM server 210 of the vendor site 202. Further, due to the registration or federation, information about the model, its swidTag and right to use requirements are sent to the client site 204 over the AI platform peering tunnel 206. Upon receipt of this information at the client site 204, the client site 204 registers the model with its local LUM server 224 in the local copy of the LUM database.

A model user 234 associated with the client site 204 may seek to use the model in the AI platform and catalog 222. The license management client 280a of the AI platform and catalog 222 contacts the LUM server 224 of the client site 204. Information in the LUM database of the LUM server 224 defines the uses that may be made of the model by users including the model user 234 at the client site. The model user 234 may deploy 226 the model as part of a business function or other operation. Further, the model user 234 may retrain the model on additional training data. In an example, the additional training data may be specific to the company, organization or entity associated with the model user 234. In other examples, the additional training data may be newer or more complete training data.

In some examples, the use of the model requires having a right to use (RTU) the model. This may be specified by associating an is RTU required flag with the model, such as in the license profile for the model. If the flag is set to True, the LUM server 224 requires an RTU agreement 220 that defines the rights and permissions of use associated with the model. An example of such a permission is a time limit of usage or a user limit of usage. The RTU agreement 220 may be defined in any suitable manner, such as using Open Digital Rights Language (ODRL). In the illustrated example of FIG. 2A, the RTU agreements is created by a sales representative 236 associated with the vendor site 202, for example using the RTU editor 218. The RTU agreement 220 is conveyed to the client site 204 and provided, in the example, to an RTU representative 238 associated with the client site 204. The RTU representative 238 may import and verify the RTU agreement 220 and save the RTU agreement 220 to the LUM database of the LUM server 224. In an alternative example, the sales representative 236 may email the RTU agreement 220 to an administrator of the client site 204 for storage in the LUM server 224.

In this manner, an in other examples systems implementing similar functionality, the AI platform implements AI federation and licensing to help share, buy and sell ML models. The AI platform provides user and usage control and monetization while sharing the capabilities of some or many ML models and other AI tools among a broad range of users.

FIG. 2B is a block diagram illustrating an example, non-limiting embodiment of a system 240 functioning within the communication network of FIG. 1 in accordance with various aspects described herein. FIG. 2A, discussed, above illustrates an example of sharing models between two parties, a vendor and a client in the example illustrated in that figure. Further, the AI platform defines aspects such as license rights, usage, monetization, and other issues between the two parties.

FIG. 2B extends and enhances aspects of the two-party system of FIG. 2A to an n-party system, system 240. In the example of FIG. 2B, n is chosen to be 3. The system 240 includes a first site 242, labelled site A, a second site 244, labelled site B, and a third site 246, labelled site C. The first site 242 includes a first traffic monitoring system 248a, a first machine learning (ML) model 250a and a first artificial intelligence (AI) platform 252a. The second site 244 includes a second traffic monitoring system 248b, a second ML model 250b and a second AI platform 252b. The third site 246 includes a third traffic monitoring system 248c, a third ML model 250c and a third AI platform 252c. Other embodiments may have more than three sites and individual sites may have differing particular implementations and features. While the first site 242, the second site 244 and the third site 246 are illustrated in FIG. 2B as being generally identical in structure, such illustration is intended solely to simplify the drawing figure and the discussion. Each site may have the widest variety of structures and functions.

Further, each respective site in some examples forms or includes an Acumos instantiation. In such examples, an Acumos instantiation is closely tied and embedded into n sites, such as in data centers or behind websites or applications belonging to the n sites. The n sites are configured for co-operation in operation to perform one or more functions, such as network security. At a site, the Acumos instantiation receives local data and events and reacts to them by onboarding trained or newly already trained AI/ML models. This information may come from other data collection and ML model creation automation tools, for example. However, such embodiments are again intended to be exemplary only and any suitable AI platform or combination of AI platforms may be used in particular embodiments.

In the example, each site of the system 240 operates generally the same. The first traffic monitoring system 248a, the second traffic monitoring system 248b and the third traffic monitoring system 248c may operate in the cloud or in a data center or at different data centers to receive web traffic. The cloud may refer to servers that are accessed at a network address over a network such as the public Internet, as well as the software and databases that run on those servers. Cloud servers may be located in data centers all over the world. Operation of the cloud and its components is generally independent of physical location. The example of FIG. 2B relates to web traffic, but traffic received at the first site 242, the second site 244 and the third site 246 could be any traffic and relate to any type of problem in general.

The first traffic monitoring system 248a, the second traffic monitoring system 248b and the third traffic monitoring system 248c respond to the received traffic to build machine learning models, including the first ML model 250a, the second ML model 250b and the third ML model 250c. Any suitable machine learning model or other artificial intelligence tool may be developed. As one example, a Random Forest classifier model may be developed and trained using the traffic received by a respective traffic monitoring system at each site. In examples, the same or similar ML models are trained at each site on the particular traffic received at each site. In other examples, the respective models may differ in particular aspects or be of varying designs. Any suitable ML model or other AI tool may be used at each respective site.

The ML model at each site, including ML model 250a, ML model 250b and ML model 250c, may be shared with a respective AI platform, including first AI platform 252a, second AI platform 252b and third AI platform 252c, respectively. In particular embodiments, at each respective site including the first site 242, the second site 244 and the third site 246, the respective ML model may be onboarded using the Acumos system wherein each of the first AI platform 252a, second AI platform 252b and third AI platform 252c is implemented as an instance of the Acumos system. The Acumos onboarding process wraps the ML model in particular Acumos style APIs and makes the respective ML model a microservice. In general, cloud-native applications may be built by a system such as an AI platform by bundling code into containers, which are standard, portable packages of software. The containers may be deployed by the AI platform as microservices, which are core functions that are built and delivered independently of one another. Deployment as a microservice makes such applications more portable and allows them to run across environments with minimal modifications.

In the particular embodiments using the Acumos system, in addition to the onboarding features of the Acumos system, the system 240 can make use of the federation features of the Acumos system. In the example, one or more of the first AI platform 252a, second AI platform 252b and third AI platform 252c can share with or federate with another AI platform using the Acumos federation feature. In an example, the first AI platform 252a, in which the first ML model 250 has been onboarded, can receive the second ML model 250b from the second site 244 and the third ML model 250c from the third site 246. In embodiments that do not make use of the Acumos system, other complementary types of sharing or federation may be used to share one or more ML models.

In embodiments, including embodiments using the Acumos system, a site including a platform such as AI platform 252s can affirmatively pull an AI tool such as an ML model to the platform. Rules and procedures may be created to enable the platform to manually or automatically search a catalog of available AI tools and obtain the latest copy of an AI tool of interest. In embodiments, this may be done according to a schedule or at set periods. This may ensure, for example, that the platform has the most up-to-date version of the ML model or AI tool available. While a particular tool or model may be onboarded from another site or AI platform, a particular AI platform may also identify, select and pull to the AI platform an AI tool of interest.

In the particular embodiments using the Acumos system, the design studio capability of the Acumos system may be used to compose an AI pipeline out of the respective ML models from the first site 242, the second site 244 and the third site 246. In an example, a composite solution similar to the system 256 illustrated in FIG. 2C may be developed at each of the first site 242, the second site 244 and the third site 246. The composite solution may be referred to as a complex AI pipeline. The complex AI pipeline may be deployed as a microservice or web service by a traffic monitoring system or other component. In embodiments that do not make use of the Acumos system, other complementary types of complex model development and deployment may be used to share a combination of ML models.

Upon development of a complex AI pipeline at each respective site, the complex AI pipeline may be deployed at each respective site. Thus, at the first site 242, the complex AI pipeline including ML model 250a, second ML model 250b, and third ML model 250c may be deployed at first traffic monitoring system 248a. Similarly, at the second site 244, the complex AI pipeline including ML model 250a, second ML model 250b, and third ML model 250c may be deployed at second traffic monitoring system 248b. Further, at the third site 246, the complex AI pipeline including ML model 250a, second ML model 250b, and third ML model 250c may be deployed at third traffic monitoring system 248c. The microservice based on the composite model or complex AI pipeline may be deployed in the cloud to monitor web traffic at a site.

Each respective complex AI pipeline may include any suitable combination of ML models or other AI tools from each AI platform in the system 240. Some sites may develop or have onboarded more than one ML model or other AI tools and these may be selected by a user or selected automatically to be shared or federated with other sites of the system 240. In some embodiments, a user operating at a local site or managing several sites may select ML models from other sites to combine with one or more models from the local site. The user may select models based on any suitable criteria, such as a desire to employ similar models trained on different data, or a desire to use different models with different capabilities. In general, the models are selected by the user to perform a particular design goal, such as network security or image analysis, and with assurance by the user that the models are compatible. In some examples, some or all portions of the selecting and combining may be automated by the AI platform or other control system.

By way of illustration of operation, a particular use case may be described involving network security. Generally, most security attacks come from multiple coordinated sources rather than a single source. The attacking sources operate in a cooperative fashion. In accordance with embodiments herein, a system may provide a cooperative and coordinated security solution at multiple sites operated by a single or multiple entities to protect against such coordinated attacks.

Each respective site of the first site 242, the second site 244 and the third site 246 receives network traffic. The network traffic may be in the form of data communications from remote sources. The network traffic may be in any suitable embodiment, such as hypertext transport protocol (HTTP), Ethernet, internet protocol (IP), etc. The network traffic generally includes a plurality of packets, and each packet has a payload along with a source address, a destination address, and other control information. In a particular example, each site of the n sites have web servers which are continuously receiving network traffic.

In the example, each site is arranged to do a continuous monitoring of the incoming web traffic to block attack-type traffic and allow legitimate traffic. Attack traffic may include malicious or unpermitted traffic seeking to do damage to facilities of an operator of any of the sites. Attack traffic may be of any attack type designed to raise a problem such as a Distributed Denial of Service (DDOS) attack. The attack may be carried out in a co-operative fashion by multiple bad actors. Generally, a DDOS attack involves a bad actor using a network of hijacked computers to flood a targeted resource with phony requests. The effect can be to leave no available bandwidth for legitimate traffic.

In an example, a dataset identified as CICDDOD2019 can be used to simulate such an attack and suggests a new DDOS attack detection and classification approach. The new classification approach analyzes some new types of transmission control protocol (TCP), or user datagram protocol (UDP) based attacks that can be carried out at the application layer and proposes a new taxonomy for their classification. The dataset contains DDOS attacks traffic metrics as well as benign traffic metrics containing timestamp, source IP addresses, destination IP addresses, source and destination ports, protocols used, etc. There are 84 features in the dataset. The dataset was built on the idea of capturing the behavior of 25 users using hyper-text transfer protocol (http), secure hypertext transfer protocol (http) s, file transfer protocol (ftp), secure shell (ssh), and email protocols, and different types of attacks. In an example embodiment, a Random Forest classifier was trained and tested on a 66.66 percent train and 33.33 percent test dataset and yielded a very high accuracy of 99.55 percent. The exemplary embodiment can accurately classify traffic as benign or malignant and, if malignant, as well as accurately identify what type of DDOS attack is underway.

The first site 242, the second site 244 and the third site 246 may be operated together by a single entity, such as a company providing data security services or online access. In other examples, the first site 242, the second site 244 and the third site 246 may be operated cooperatively by two or more individuals, organizations or companies. The sites may be operated at different network locations or addresses, at different geographic locations, or in conjunction with different functional aspects of an organization. For example, the first site 242 may receive internet traffic at a publicly available search function of an entity, second site 244 may receive retail sales traffic at a different network site of the entity, and the third site 246 may receive internal business traffic of the entity.

In an example embodiment, each respective site of the n sites, including the first site 242, the second site 244, and the third site 246, builds an ML model on respective local data and then federates or shares the local ML model with the other sites so the local ML data can be used at the new sites. In one example, the ML model may be a random forest classifier model trained to get a very high accuracy to differentiate between malicious traffic and benign traffic and also, in the process, to predict, if the traffic is malicious, then what type of an attack might be occurring. In general, the noted data processing is happening independently, in parallel at the three sites.

In examples, the ML models may be reusable models. It has been observed that the ML model 250a, the ML model 250b and the ML model 250c have no bearing or do not take into account features of the traffic such as the IP source address, the IP destination address, the source port and the destination port features of the traffic. That is, information about where the traffic is coming from and where the traffic is going to, the sender and the receiver, is not important to the accuracy of the model. The model can still predict whether a DDOS attack is taking place and, if so, then what type of a distributed service attack is taking place, based just on the behavior and the metrics and the metadata available about the traffic.

Thus, a model developed at one location, such as one of first site 242, second site 244 and third site 246, can be used elsewhere, at another site. The model is independent of sender and receiver, IP addresses and ports, so the model becomes reusable and portable for use elsewhere.

In another example, the origins of data that are used to develop and train the model may have a wide variety. For example, medical data may originate from patients located all over the world. The data are anonymized to preserve confidentiality. Once a model is developed based on the anonymized data, the model is not being shared but behavior of according to the data is being shared.

Compatibility and shareability of models may be based on training data used for the models. The models available for sharing to an AI platform may be maintained in a catalog and the catalog may include descriptive information about training data, model inputs, model outputs, and others. Providing such descriptive information and metadata may be a required part of submitting a model to the catalog.

In accordance with such model portability, then, more than one model may be combined and operate in, for example, a pipeline fashion at each site. Thus, in the example of FIG. 2B, the first site 242 has built and trained ML model 250a. Similar ML models may be built and trained at the other sites, including ML model 250b at second site 244 and ML model 250c at third site 246. The ML model 250b and the ML model 250c can then be shared with the first site 242. The ML model 250a may be pipelined at first site 242 with the ML model 250b and the ML model 250c shared from the other sites. In one example using the Acumos platform, the Acumos system includes a design studio feature with allows combination of models. Other platforms or systems may include similar features. In a similar manner, the three ML models, including ML model 250a, ML model 250b and the ML model 250c can be shared at the second site 244 and the third site 246 to create a pipeline of models at each site. The pipeline of ML models becomes, in effect, a more robust ML model for detecting DDOS attach.

In accordance with some embodiments, multiple ML models or other AI tools may only be combined if they are mutually compatible. Compatibility in some embodiments is related to the application programming interfaces (APIs) used by or created for the models. The APIs define certain input and output information including data format and data content. If the input and output information for the APIs match or conform in a suitable manner, the ML models may be combined. In a particular example, the design studio function of the Acumos product will only combine models that are recognized to be compatible. When a ML model is onboarded into the Acumos system, the onboarding process creates the APIs for the ML models. The Acumos design studio will verify compatibility before permitting combination of multiple ML models. Other AI platforms may ensure compatibility in other manners.

In some embodiments, there may be a library or catalog of ML models or AI tools which may be accessed by each respective site. The ML models or AI tools in the catalog may be contributed by any suitable entity or participant. The contributor may specify access controls that make a contribution fully publicly available or limit access on any suitable basis, including according to licensing terms. Any site seeking to access and use a model or tool from the catalog does so according to the terms set by the contributor.

The system 240 of FIG. 2B and comparable embodiments provide many advantages. First, the system offers a way to crowdsource data among multiple sites implementing multiple ML models or other AI tools. Regulations such as the General Data Protection Regulation (GDPR) of the European Union and the California Consumer Privacy Act (CCPA) may limit the extent to which data received at one site, such as first site 242, may be shared with other sites such as the second site 244. Sharing of the actual data may be prohibited, but the parties can share characteristics of the data by sharing ML models that have been trained on that data.

These advantages may particularly apply to particular data processing fields. Such fields of applicability include network security, including protecting against a DDOS attack as in the example embodiment and such as malicious traffic recognition. Such fields of applicability further include remote sensing. In data processing, it may not be practical to share data from a first location or site where the data is collected to a second site that is remote. Sharing the characteristics of the sensed data by sharing a ML model trained on the data may provide and excellent workaround. Such fields of applicability may include medical trials in which maintaining data confidentiality is crucial. Instead of sharing the actual data, parties may share aggregate behavior in the form of ML models developed with the actual data and that can be reused.

Other advantages of the systems described and exemplified herein include crowdsourcing model training and compute power. Large, realizable models require substantial computing power for training and inference. Using multiple models or AI tools and combining them in a complex AI pipeline allows the separate models to be sourced from different entities to provide one or more combined solutions from n different sites. Moreover, when models are shared from site to site, the human experience of the model developers at each site is shared as well. In this manner, a first site that has a focus on some field other than network security can reap the benefits of one or more sites that do have a security focus and a depth of experience. For example, an non-governmental organization (NGO) team at one site or a healthcare institution at another site may benefit from more sophisticated network security models developed by a team at a security-focused site or entity.

Other advantages of the systems described herein include reducing redundancy of work. The same problem may have been solved elsewhere, by another entity. Rather than repeat the work to develop a suitable model or other AI tools, an entity can make use of the prior solution in a local system.

Other advantages of the described systems include providing a way to crowdsource experience. For example, in the exemplary embodiment of FIG. 2B, the capabilities of the models at first site 242 are complemented or augmented by using the experiences of second site 244 and third site 246. Those sites are exposed to traffic and other inputs that the first site 242 will never see. This effectively shares the experience of the other sites and makes the resulting composite model more robust.

FIG. 2C is a block diagram illustrating an example, non-limiting embodiment of a system 260 functioning within the communication network of FIG. 1 in accordance with various aspects described herein. The system 256 may operate as a complex artificial intelligence (AI) pipeline in conjunction with the system 240 of FIG. 2B or with similar systems. The system 260 may be instantiated at each site of the system 240 as a complex AI pipeline at each site, where each site includes combined models from the first site 242, the second site 244 and the third site 246.

In the illustrated example embodiment, the system 260 includes a splitter 262, a first ML model 250a, a second ML model 250b, a third ML model 250c, a collator 264 and a hard voter 266. Other embodiments may include other or different features. For example, the embodiment of FIG. 2C includes three ML models operating as a complex AI pipeline including first ML model 250a, second ML model 250b, and third ML model 250c. Other embodiments may include fewer or more ML models operating in parallel or in a pipeline structure. Further, in some embodiments, the ML models forming the complex AI pipeline of the system 260 may be similar ML models or similar ML models trained on different training data. In other examples, the ML models forming the complex AI pipeline of the system 260 may be different ML models or different types of ML models.

In some examples, the system 260 may be embodied as software such as Python code or Java code instantiating the components of the system 260. Other embodiments may be used as well. The system 260 operates in place of or as an instance of the ML model in each of the first site 242, the second site 244 and the third site 246 in FIG. 2B. The system 260 operates, for example, to identify malicious web traffic received at a traffic monitoring system such as first traffic monitoring system 248a at the first site 242.

In the example of FIG. 2C, the splitter 262 receives web traffic received at the respective site where the system 260 is implemented. The splitter 262 operates to distribute or broadcast copies of the received traffic to each so the ML models of the system 260, including in this example, the first ML model 250a, the second ML model 250b, and the third ML model 250c. In a complementary manner, the collator 264 receives a result or conclusion from each respective model of the system 260 and provides a collated result or group of results to the hard voter 266.

The exemplary system 260 is a voting model in that conclusions from each individual ML model are combined and a majority result is determined. In the example, the system 260 is used for analyzing received web traffic and concluding if the received traffic is malicious or benign. The web traffic may include any group of one or more packets received at a site or a group of cooperating sites. The web traffic packets may include a header with addressing information and other control information, along with a payload. Other packets may include other formats. The packets may be formatted according to any standard such as TCP/IP.

Each model, including the first ML model 250a, the second ML model 250b, and the third ML model 250c, receives the same item of traffic. Each respective model generates a conclusion about the received item of traffic, malicious or benign. The hard voter 266 determines the final conclusion, malicious or benign, for the particular item of web traffic, based on the respective conclusions of the respective ML models in the system 260.

In one voting model example of FIG. 2C, a majority rules model is applied. That is, each of the three ML models forms a conclusion about the same item of web traffic, whether the item of web traffic is malicious or benign. If at least two of the three ML models among first ML model 250a, second ML model 250b, and third ML model 250c conclude the traffic is malicious, the traffic is treated as malicious and quarantined, deleted or otherwise handled accordingly. Else, the model is treated as benign. This may be considered a hard voting model.

In another example, a soft voting model is applied. For example, the hard voter 266 may assign a weighting such as percentages to the result received from each respective ML model, the first ML model 250a, the second ML model 250b, and the third ML model 250c. In an example, a numerical weighting value between 0 and 1 is assigned to the result of each model, and multiplying by the weighting value. The result of each model is nominally binary in nature, benign or malicious. In one example, each model result is equally weighted at 0.33 and the results are combined. In another example, one or more model results are weighted differently. For example, if the system 260 is operating at the first site 242 (FIG. 2B), the first site 242 may weight the results of the first ML model 250a more heavily, such as 0.5. The results from the other two models may be weighted differently, such as 0.25 each. In this example, the system 260 at the first site 242 uses a heavier weighting on the locally-derived model because, perhaps, the results of the locally-derived model are considered more relevant to evaluating newly received web traffic. For example, a site situated in Georgia would give higher weights to the outputs of models from the state of Georgia, as an example of weighting according to geography, and give the highest weight to the model that was trained at its own site. Other weightings and combinations may be used as well.

In some embodiments, the system 260 may implement a type of feedback loop to adjust weightings given to the output of each respective ML model. If, for example, the hard voter 266 or other evaluator determines that one model or another is giving a consistently better result, the evaluator may provide feedback based on that determination to adjust the weightings given to the outputs of the ML models. The model giving a better result may be weighted more heavily. On the other hand, if the evaluator determines that a particular model is giving a consistently worse result, the evaluator may adjust one or more weightings to reduce the weight given to the results of that model.

In an example, the evaluator may be a module including code, hardware or a combination, which compares the ongoing results of the system with known values or baseline values. For example, each model has its own local data and results to compare as a baseline with ongoing results from the system 260. The system 260 at a particular site knows the results for particular received data at the site where the system is located. Such data was collected at the site and is not subject any restrictions such as CPC or GDPR, for example.

Other voting schemes may be selected as well. For example, if only one model concludes the traffic is malicious, the traffic may be discarded or quarantined, or the traffic may be determined to be malicious only on a unanimous vote of all three models. In other examples where more than three models are combined, other voting schemes such as percentage schemes may be used as well.

As noted, the system 240 of FIG. 2B and the system 260 of FIG. 2C may be applied to the widest variety of problems. Monitoring network security and detecting malicious data, as described, is one solution. A further solution relates to monitoring, for example, remote sensing. Yet another solution relates to monitoring medical device data or medical testing data. For each of these problems and others, the system 240 and the system 260 provide a distributed solution that allows multiple sites or processing systems to operate in coordination to identify and resolve noted problems.

Moreover, the method and apparatus described herein may be readily extended to more sites that then three sites illustrated in, for example, FIG. 2B. The number n of sites may be any suitable number. However, the solution provided may be readily scaled to any number of sites. Any number of new collaborators or new partners may be onboarded by sharing one or more ML models or other AI tools. In this manner, new training data may be added, new training and model design experience may be added, and additional computer power may be added to the distributed solution. A diverse group of collaborators, across the widest geography, can work together on a common problem by sharing AI tools on an AI platform such as Acumos or other type of AI platform.

In additional embodiments, the arrangement illustrated in FIGS. 2B and 2C, for example, can be extended to be a no click automatic deployment of the composite solution or the complex AI pipeline. Once federation is established among a group of sites, that federation or sharing remains in place. As noted above, each platform including the system 240 may from time to time pull in the latest copy of an AI tool from another site. In FIG. 2B, the first AI platform 252a at first site 242 can pull in the latest version of the second ML model 250b and the third ML model 250c. In embodiments, this model pull process can be set to a regular period, such as once per hour or once per day. In this way, the first AI platform 252a will always get the best-trained model or the model trained on the freshest training data from all these n different sites.

Further, the process of deploying the complex AI pipeline can be automated according to a schedule as well. For example, updated models may be pulled into the AI platform daily at midnight. Sometime later in the day, the new models are combined to create the complex AI solution and the complex AI solution is deployed at a local site and at any remote sites, as is required by the design.

Such an automated process enables a near real time collaboration between n different entities. In this example, near real time collaboration may mean a response to a change circumstance within one to twenty-four hours from the occurrence of the change. In particular, in use cases involving network security, there is a high degree of urgency in the area of network security because new attacks can happen and propagate within a matter of hours.

FIG. 2D depicts an illustrative embodiment of a method 270 in accordance with various aspects described herein. The method 270 may be implemented in any suitable fashion on any appropriate data processing system or combination of data processing systems. The method 270 may operate to implement a network security function by composing artificial intelligence (AI) pipelines or composite solutions out of individual models. The individual models are trained at different sites on different training data and then federated or shared among the different sites. Any number of sites may cooperate to provide the network security function. The sites may be implemented in different locations such as data centers or as network slices accessible over a network such as the public internet.

In a particular embodiment, the method 270 may include implementation at three sites which may be referred to as site A, site B and site C. Each site includes one or more application servers that receive network traffic, such as web traffic. Each site monitors for malicious or benign traffic and rejects or isolates any detected malicious traffic. At site A, there is continuous monitoring of incoming web traffic to the application servers. The incoming web traffic is used to train a machine learning model, deep learning model or other AI tool to detect malicious traffic such as DDOS attack type traffic. Once the model is trained at site A based on the local incoming traffic as training data that it has seen, the model is onboarded into an AI platform at site A to make the model federatable or shareable and also convert it into a containerized microservice. The model is (federated) shared with complementary AI platforms at the remaining two sites, site B and site C. In a particular illustrative embodiment, the complementary AI platforms at the sites may implement instances of Acumos. Other AI platforms having additional or alternative capabilities may be used as well. The multiple sites, site A, site B and site C, may belong to the same entity such as a company or different entities such as different companies. In some embodiments, federation may include monetization and licensing aspects in a transaction. The other two sites, site B and site C, also develop local models and share their local models with the other sites. The method 270 may be implemented at any or all of the sites.

At step 272, an AI tool such as a ML model is selected for use at a site of a multiple-site system operated as a complex artificial intelligence (AI) pipeline. Any suitable AI tool may be selected, including for example, ML models or deep learning models. The selection of the model may be based on the function to be performed by the complex AI pipeline at the site or by the nature of the training data available for training the model. Similarly, model parameters may be selected or specified based on the nature of the training data available or the task to be performed.

At step 274, data is received at the site. In an example, the data includes web traffic received from various sources over a network such as the public internet. The data may include timestamp information, source IP addresses, destination IP addresses, source and destination ports, protocols used, and other information. The data may be received continuously. Other sites that are to be federated with the site may similarly receive data from various sources. The other sites receive different data. The different data received at the other sites may be similar in nature or different in nature from the data received by the site at step 274.

At step 276, the model or other AI tool selected at step 272 is trained using the data received at step 274. Any suitable training may be used. The model is trained on the local data received at the site. Similarly, at other respective sites, the respective models selected at the respective sites are trained using the local data received at the respective site. This has the effect of parallelizing the training process for multiple models that are to be shared or federated to form the complex AI pipeline. In this way, training of models on local data, and sharing the models to create a solution at a remote site, for that remote site, harnesses the power of crowdsourcing of data and compute power from other sites. Further, since in some instances, the sharing of data is prohibited, the sharing of the model developed or trained from the local data at remote sites allows the remote sites to benefit from the exposure to that data, thus sharing the expertise of each site with other sites.

At step 278, the model developed at the site and trained at step 276 is shared with other sites. While a single model is indicated as being selected, trained and shared at each site, in some embodiments, multiple models may be developed and shared at one or more site. Further, in some embodiments, a catalog or library of models may be developed and made available to other sites. Sharing a model may be done in any suitable manner. In the exemplary embodiment using the Acumos system, the Acumos system includes features for onboarding a model from one site to another and federating the sites and models to share models.

At step 280, the site may pull additional models from other sites. As noted, a catalog may be developed and the site may select one or more models from the catalog and federate the selected model with the model developed locally at the site using locally received data. In the example, the site implements a complex AI pipeline using n models, so up to n-/models may be pulled into the site.

At step 282, the models may be combined at the site to form the complex AI pipeline. In an example, the combined models include a model developed locally using local training data, and models developed at other federated sites using training data local to those sites. In the exemplary embodiment using the Acumos system, the Acumos system includes a design studio feature that facilitates combining models to operate together as a complex AI pipeline. Other AI platforms may provide similar capabilities.

In some embodiments, a user operating at a local site or managing several sites may select ML models from other sites to combine with one or more models from the local site. For example, a medical diagnostics team at one site may benefit from drug trialing models or for, for example, cancer diagnostics models developed by a team elsewhere, without actually getting all that data or conducting those trials. This could be because it might be interested in models trained on either more similar data in the case that sufficient data samples were not collected at the site in question or entirely different data in case that data can only come from certain specific site. The teams may make use of whatever can combine to help make the model at the current site more robust. This also makes it possible to hold or have multiple parallel data collection and trials, and combine results together later as needed.

The user may select models based on any suitable criteria, such as a desire to employ similar models trained on different data, or a desire to use different models with different capabilities. In general, the models are selected by the user to perform a particular design goal, such as network security or image analysis, and with assurance by the user that the models are compatible. In one example, the AI platform receives from the user, operating a control system, selection information defining a selection of models to use. The selection information may define a particular model in a catalog or library of shared models, or may specify a model to pull from another site. Further, the selection information may specify a frequency or period for updating the specified model, such as a frequency at which an updated version of the model should be pulled from another site. In some examples, some or all portions of the selecting and combining may be automated by the AI platform or other control system.

In an example, models to be combined should generally have compatibility among input information and output information. The result of the complex AI pipeline may be a decision about the nature of received data at the site, such as whether received data is malicious and should be rejected or isolated. Rejection may include deleting the received data immediately. Isolation may include storing the received data in a data store which is segregated from other data processing facilities in order to prevent the malicious traffic from affecting equipment of the sites such as an AI platform or servers of the site. The isolated data may subsequently be evaluated to learn about any attempted attack on the site. Malicious traffic or received data should be rejected or isolated from other equipment of the site in order to protect the site from a malicious attack that could affect equipment of data of the entity operating the site.

At step 284, the site begins receiving input data and evaluating the nature of the input data using the complex AI pipeline including the combined models. Similarly, other federated sites may begin receiving local data and making decisions about the received data. Any number of models or sites may operate together. Each site generally operates simultaneously with the other sites to process locally-received data. In general, n sites are continuously connected and co-operate continuously.

At step 286, the input data received at step 284 is applied to the combined models. More specifically, the local data are applied to the complex AI pipeline formed from the federated models including the locally-developed models combined with models developed at other sites. Any arrangement of models and application of data may be established including a sequence of models evaluating a set of input data and results or a parallel arrangement of models such as first ML model 250a, second ML model 250b and third ML model 250c illustrated in FIG. 2C.

In step 288, a determination is made whether the traffic or input data received at step 284 is malicious or benign. In general, the federated models forming the complex AI pipeline at the site make the determination. In an example, each respective model develops a respective conclusion, malignant or benign, and the final determination is based on the respective conclusions. This may be done, for example, by a majority voting operation, by weighting the respective conclusions, or in any other suitable manner. If the complex AI pipeline determines the traffic received at step 284 is malicious, the traffic may be isolated or rejected at step 290 to protect the site from a malicious attack that could affect equipment of data of the entity operating the site. Isolation or rejection may be done in any suitable manner, and may include further analysis to identify the nature of the malicious attack. For example, if the traffic is merely suspected of being malicious, the data may be quarantined until further analysis may be performed. Further, if the traffic is determined to be malicious, one or more of the ML models forming the composite model of the site may be modified to more reliably recognize future malicious traffic received at the site.

At step 292, it is determined if the model should be adjusted. This determination may be based on any suitable information. For example, if performance of one particular model of the complex AI pipeline is performing better or worse than expected, and weighting percentages are used to weight the respective conclusions of the models, the weighting percentages may be adjusted to improve performance. In an example, the ongoing performance of each model may be compared with a known baseline for performance.

In another example, if may be determined at step 292 to retrain or additionally train one or more of the models forming the complex AI pipeline. Retraining may be performed using any suitable training data including live, currently received web data at the site. For example, if the nature of the local traffic received at the site evolves over time, the models may need to be retrained to better detect a malicious attack. The attacker may change to a different style of attack or otherwise modify the type attacking data communicated to the site. Updating training for each of the models allows the overall complex AI pipeline to evolve along with the evolution of the data.

If an adjustment is determined to be necessary, control may proceed to step 294 to perform any adjustments considered necessary or appropriate. The adjustment may be determined to be necessary based on comparison of current performance with a predetermined baseline performance, for example.

In step 296, it is determined if one or more models should be updated. As noted, in some embodiments, a site may pull in a model from the site where the model is developed or from a catalog of current models. In the example, the respective sites are continuing to train and otherwise develop the respective models developed at the respective sites. As local data changes and evolves, a continuous training process allows the model to develop based on the changing traffic and to remain most effective at identifying malicious web traffic. Thus, by updating one or more models at the site, the site will always get the best trained model or the model trained on the freshest training data from all the n different sites. In embodiments, operational sites, websites, datacenters, applications and other data processing facilities are continuously collecting external or internal data such as security data, performance data, etc., depending on the application. The sites are continuously building updated AI tools such as ML models or DL models using suitable tools and languages available. The sites are further continuously onboarding the AI tools or models into a local AI platform and continuously sharing the models as the models are updated. Further, the sites are continuously employing the AI tools and models in designed AI inference pipelines at other sites and the current site. The sites continuously have the latest AI inference pipelines operational to perform the ML task using the inference pipelines or complex AI pipelines.

If it is determined that the models should be updates, at step 298 the one or more models are updated. For example, a latest version of the model currently in use may be pulled in to the site and substituted for the existing version of the model. In another example, if an additional model is available, the additional model may be pulled in, federated with the existing models and initiated into operation.

In an example, the process of updating the models may be performed according to any suitable schedule or in response to any condition. For example, the models may be automatically updated hourly or daily or at any other period. Further, if model performance is considered to be degraded, one or more models may be updated. This may be done automatically, without human intervention, as required. Control returns to step 284 to continue receiving data at the site.

The illustrated approaches show how a model can be trained locally on local data and then shared with a new remote site to create an AI pipeline to augment the capabilities of a similar model at that new site with the model. In a way, this training of models on local data, and sharing them to create a solution at a remote site, for that remote site, harnesses the power of crowdsourcing of data and compute from other sites. This co-operative and coordinated approach to solving problems can help solve such problems much more efficiently too. The illustrated use case shows initiating a co-operative and coordinated defense that identifies and classifies attack types against a problem like the Distributed Denial of Service (DDOS) attack, that itself is carried out in a co-operative fashion by bad actors.

While for purposes of simplicity of explanation, the respective processes are shown and described as a series of blocks in FIG. 2D, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

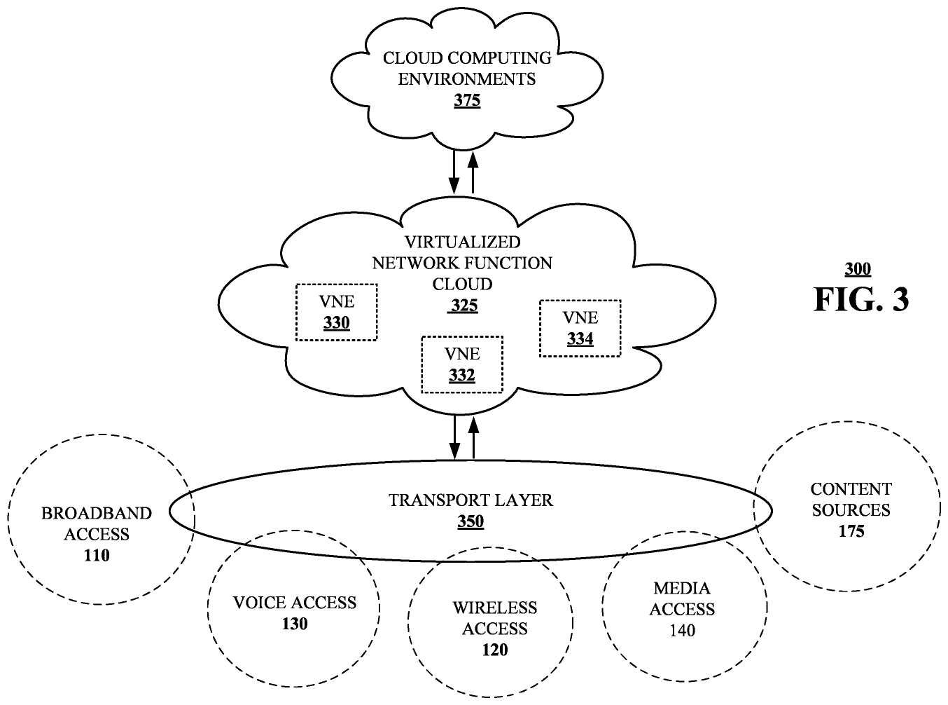

Referring now to FIG. 3, a block diagram is shown illustrating an example, non-limiting embodiment of a virtualized communication network 300 in accordance with various aspects described herein. In particular a virtualized communication network is presented that can be used to implement some or all of the subsystems and functions of system 100, the subsystems and functions of system 200, system 240, system 260 and method 270 presented in FIG. 1, FIG. 2A, FIG. 2B, FIG. 2C, FIGS. 2D, and 3. For example, virtualized communication network 300 can facilitate in whole or in part detecting malicious received data at a web site or network location using a composite AI pipeline formed from multiple ML models. The ML models include models trained locally and models trained at remote network sites. The operation of the ML models is coordinated and continuous, and the models are continuously updated to provide the best performance for identifying malicious traffic.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

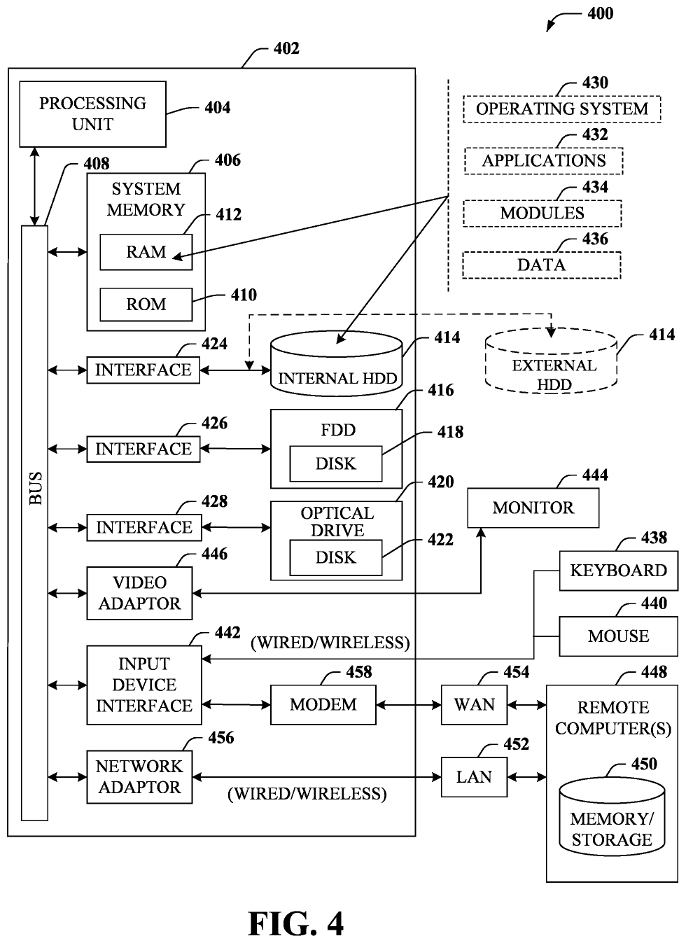

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part detecting malicious received data at a web site or network location using a composite AI pipeline formed from multiple ML models. The ML models include models trained locally and models trained at remote network sites. The operation of the ML models is coordinated and continuous, and the models are continuously updated to provide the best performance for identifying malicious traffic.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures.

The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

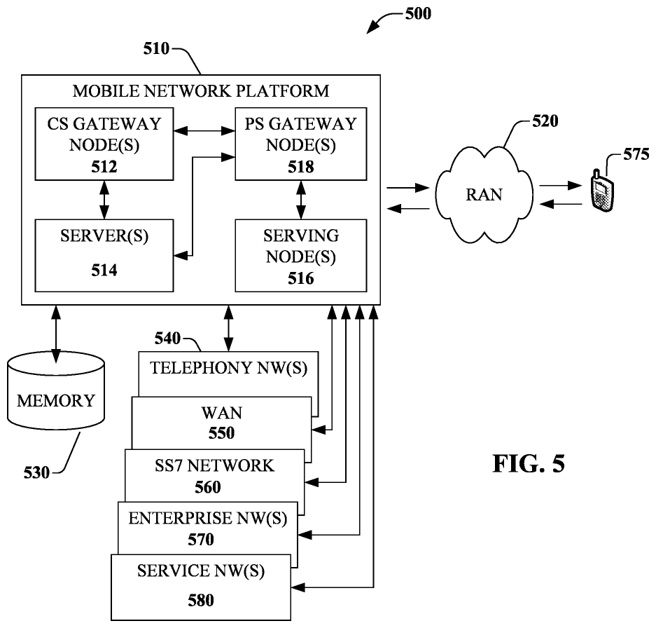

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part detecting malicious received data at a web site or network location using a composite AI pipeline formed from multiple ML models. The ML models include models trained locally and models trained at remote network sites. The operation of the ML models is coordinated and continuous, and the models are continuously updated to provide the best performance for identifying malicious traffic. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technologies utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

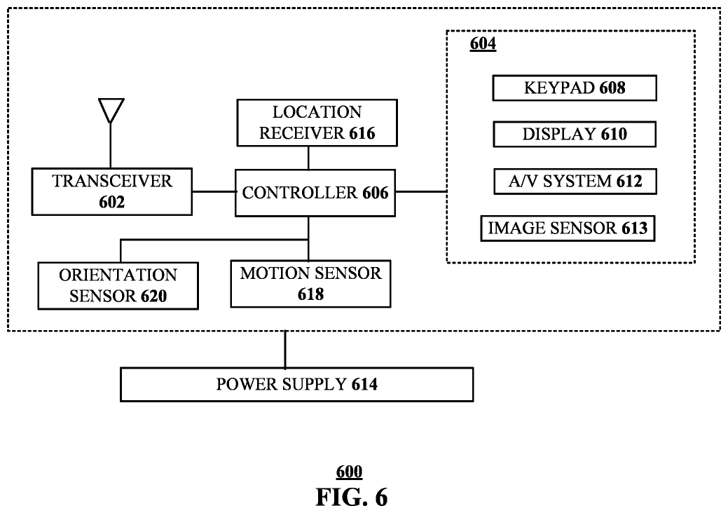

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part detecting malicious received data at a web site or network location using a composite AI pipeline formed from multiple ML models. The ML models include models trained locally and models trained at remote network sites. The operation of the ML models is coordinated and continuous, and the models are continuously updated to provide the best performance for identifying malicious traffic.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VOIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, X=(x1, x2, x3, x4, . . . , xn), to a confidence that the input belongs to a class, that is, f (x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
training a first machine learning (ML) model on first local data received at a first site;
combining the first ML model with a plurality of other ML models to form a composite model, each respective ML model of the plurality of ML models trained by a respective site of a plurality of sites using respective local data at the respective site;
receiving input data at the first site;
providing the input data to the composite model;
determining, responsive to the composite model, a status of the input data, wherein the status comprises one of malicious data and benign data; and
isolating the input data responsive to a determination of a status of malicious data.

2. The device of claim 1, wherein the operations further comprise:
sharing the first ML model with respective sites of the plurality of sites.

3. The device of claim 1, wherein the operations further comprise:
updating the first ML model, forming an updated first ML model; and
sharing the updated first ML model with respective sites of the plurality of sites.

4. The device of claim 3, wherein the operations further comprise:
receiving updated respective ML models from respective sites of the plurality of sites;
replacing a current ML model of the plurality of ML models with the updated respective ML models to update the composite model, forming an updated composite model;
receiving additional input data at the first site; and
providing the additional input data to the updated composite model.

5. The device of claim 1, wherein the operations further comprise:
continuously updating the first ML model, forming continuously updated first ML models;
sharing the continuously updated first ML model with respective sites of the plurality of sites;
receiving continuously updated shared ML models from respective sites of the plurality of sites; and
replacing current ML models of the plurality of ML models with the continuously updated respective share ML models to update the composite model, forming a continuously updated composite model;
receiving additional input data at the first site; and
providing the additional input data to the updated continuously composite model.

6. The device of claim 1, wherein the determining the status of the input data, comprises:
receiving, from each respective model of the first ML model and the plurality of other ML models, respective status information for the input data; and
determining the status of the input data based on the respective status information.

7. The device of claim 6, wherein the operations further comprise:
applying a majority rules model to the respective status information from each respective model of the first ML model and the plurality of other ML models.

8. The device of claim 6, wherein the operations further comprise:
applying a weighting value to the respective status information from each respective model of the first ML model and the plurality of other ML models, producing weighted status values; and
determining the status of the input data based on the weighted status values.

9. The device of claim 8, wherein the applying a weighting value to the respective status information comprises:
weighting received status information from the first ML model more heavily than receives status information from the plurality of other ML models.

10. The device of claim 8, wherein the operations further comprise:
continuously adjusting weightings value applied the respective status information from each respective model of the first ML model and the plurality of other ML models to improve accuracy of the composite model.

11. A machine-readable medium, comprising executable instructions that, when executed by a processing system including a processor, facilitate performance of operations, the operations comprising:
combining a plurality of machine learning (ML) models to form a composite model, the plurality of ML models including a first ML model trained on first local data received at a first network location and added models including a second ML model through an nth ML model, respective added models of the added models each being respectively trained on respective training data at a respective network location remote from the first network location;
receiving input data at the first network location;
providing the input data to the composite model;
receiving, from the composite model, a conclusion about a status of the input data;
receiving an indication to update one or more models of the plurality of ML models; and
updating the one or more models according to the indication.

12. The machine-readable medium of claim 11, wherein the receiving an indication to update one or more models comprises:
receiving an indication from a user to update the one or more models.

13. The machine-readable medium of claim 11, wherein the receiving an indication to update one or more models comprises:
automatically receiving an updated model for the added models.

14. The machine-readable medium of claim 11, wherein the receiving an indication to update one or more models comprises:
pulling to the first network location an updated model corresponding to each of the one or more models, wherein the pulling is according to an automatic updating schedule.

15. The machine-readable medium of claim 11, wherein the operations comprise:
from time to time, adjusting characteristics of one or more models of the plurality of ML models to improve performance of the composite model.

16. The machine-readable medium of claim 11, wherein the operations comprise:
continuously updating the first ML model to develop an updated first ML model at the first network location;
continuously receiving updated added models including an updated second ML model through an updated nth ML model from remote network locations; and
updating the composite model with the updated first ML model and the updated second ML model through the updated nth ML model.

17. A method, comprising:
training, by a processing system including a processor, a local machine learning (ML) model on first local data received at a first network location;
creating, by the processing system, a local containerized microservice based on the local ML model;
receiving, by the processing system, from a plurality of remote network locations, additional containerized microservices, each respective additional containerized microservice of the additional containerized microservices being created at a respective remote network location from a respective ML model, each respective ML model being trained at the respective remote network location on respective training data;
combining, by the processing system, the local containerized microservice and the additional containerized microservices to form a composite model;
receiving, by the processing system, input data at the first network location;
providing, by the processing system, the input data to the composite model; and
receiving, by the processing system, from the composite model, a conclusion about a status of the input data.

18. The method of claim 17, wherein the receiving a conclusion about a status of the input data comprises:
receiving, by the processing system, an indication that the input data includes malicious data; and
quarantining, by the processing system, the input data.

19. The method of claim 17, further comprising:
receiving, by the processing system, updated additional containerized microservices, each respective updated additional containerized microservice being created from an updated ML model which has been updated according to fresh training data; and
updating, by the processing system, the local ML model using fresh training data received at the first network location.

20. The method of claim 19, wherein the receiving the updated additional containerized microservices comprises:
receiving, by the processing system, one or more updated containerized microservices deployed according to a predetermined schedule to improve performance of the composite model.
